(19) United States
(12) Patent Application Publication
(10) Pub. No.: US 2006/0239338 A1
(43) Pub. Date: Oct. 26, 2006

(54) Modulation feature measurement and statistical classification system and method

(76) Inventors: James Kolanek, Goleta, CA (US); Michael A. Polakowski, Dayton, OH (US); Eric C. Carlsen, Fairborn, OH (US)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 11/354,632

(22) Filed: Feb. 15, 2006

Related U.S. Application Data
(60) Provisional application No. 60/652,872, filed on Feb. 15, 2005.

(51) Int. Cl. H04B 17/00

(52) U.S. Cl. 375/224

(57) ABSTRACT

A modulation feature measurement and classification system for classifying a pulsed signal that includes a preprocessor, phase measurement system and modulation classifier. Preprocessor detects pulse starts and stops, measures pulse duration and converts the pulsed signal into digitized baseband in-phase/quadrature samples. Phase measurement system measures short chip counts, long chip counts, phase jump magnitudes, number of phase states, and polynomial coefficients for phase modulation of the pulsed signal. Modulation classifier determines modulation type based on the measurements using both rules-based and similarity-based classification methods.

### TECHNICAL FIELD OF THE INVENTION

The present invention relates to signal processing, and more particularly to pulsed signal measurement and classification by a combination of rule-based and similarity-based criteria.

### BACKGROUND OF THE INVENTION

A common problem in radio wave receivers is differentiating the signal of interest (SOI) from other signals that may be present and close to the SOI, spatially and/or electronically. An earlier feature measurement and modulation classification system performs similar functions, but has several limitations overcome by the present invention. The earlier system is completely rule based as opposed to rule and discriminant function based. The earlier system does not include a similarity metric or statistical classification. The earlier system also has a more limited set of output modulation types.

Two broad categories of approaches used in this area are neural networks and transform-based methods. Neural networks attempt to train the classifier with a large set of signals that are indicative of those commonly encountered. An unknown signal is then classified based on the response of the trained classifier. Not only is this approach completely dependent on the quality of the training set, but there is no way to ascertain the robustness of the system through intermediate results. For example, if a signal is misclassified as a Barker coded signal, it might be valuable to know that it is at least a phase shift keyed (PSK) signal (of which Barker is one of many sub-types). A more hierarchically structured classifier might be able to furnish that information; a neural network-based classifier will not.

Another approach used in this area is a combination of filters and Fourier transforms to characterize an unknown signal modulation in terms of the order of its phase: constant, linear, quadratic, etc. However, the resulting classification will be of a general nature (e.g., “PSK” rather than “Barker”). A method using Walsh transforms to obtain radar pulse “signatures” has also been proposed, but this is applied to deinterleaving multiple simultaneous pulse trains by identifying each emitter's pulse repetition interval (PRI); the purpose is not to obtain a modulation type.

) Other work in this area that is of a more specific nature typically relates to communication, not radar, signals. While there is some overlap between these two signal classes, modulation classifiers for communication signals tend to be more statistical. Higher order statistics such as cumulants may be used to characterize the signal and compare it to a set of prototypes. Another method utilizes Hidden Markov Models to differentiate between modulation types. These approaches can take advantage of the fact that a training sequence often occurs as part of a communication protocol, or the protocol is at least well defined and readily available to the parties attempting to communicate. This is generally not the case for radar signals, which often are intercepted as part of an “uncooperative collect.”

### SUMMARY OF THE INVENTION

The invention produces an estimate of the type of frequency and/or phase modulation on a pulsed signal by extracting feature information from the signal and classifying it according to a combination of rule-based and similarity-based criteria. The features include pulse duration, counter values relating to frequency and phase changes in the signal (long and short “chip counts”, respectively), phase jump amounts, phase state count, and a vector of polynomial coefficients that represent an approximation of the signal phase. The features are input to the classification algorithm, which uses two types of decisions to estimate the modulation. Rule-based decisions are made by comparing various signal features to fixed thresholds, and selecting or eliminating possible modulation types based on the result. Similarity-based decisions are made by calculating a similarity metric (the Mahalanobis distance) between the signal and a set of candidate prototype signals with various modulations, then selecting the prototype modulation with the highest degree of similarity. Classifications made using the similarity method also include a measure of confidence in the estimate, which relates the degree of similarity between the signal and the selected prototype to the degree of similarity between the signal and the other, unchosen, prototypes.

The feature measurement and modulation classification algorithm described above provides an additional parameter—modulation type—that may be used in conjunction with existing parameters to aid in differentiating the SOI from other environment signals. The modulation type may also be used to more thoroughly characterize a given SOI, even if an unambiguous track has been established.

Additional features of the invention will become apparent to those skilled in the art upon consideration of the following detailed description, accompanying drawings, and appended claims.

### BRIEF DESCRIPTIONS OF THE DRAWINGS

FIG. 1 is a top-level flow diagram of a modulation feature measurement and classification system;

FIG. 2 is a top-level flow diagram of a process for determining chip counts and phase jump magnitudes;

FIG. 3A is a more detailed flow diagram of the frequency discriminator and the anti-wrap circuit of FIG. 2;

FIG. 3B is a more detailed flow diagram of the phase jump detector of FIG. 2;

FIGS. 4A-G are exemplary plots of the signals passed between the components shown in FIGS. 2, 3A and 3B;

FIG. 5 is an exemplary plot of the phase jump levels for a signal having four phase states;

FIGS. 6A-C are diagrams depicting exemplary results of a clustering method using differing thresholds;

FIG. 7 depicts a distance function method for determining IMOP classification of an input signal;

FIG. 8 is a diagram illustrating the concept of Mahalanobis distance,

FIG. 9 is a flow diagram of the method used in the classification section of the present invention;

FIG. 10A is a confusion matrix showing the performance of the present invention;

FIG. 10B is a graphical representation of the confusion matrix shown in FIG. 10A; and

FIG. 11 is a plot showing the performance of the present invention trained using various SNR signals and showing the performance of a baseline measurement and classification system.

### DETAILED DESCRIPTION

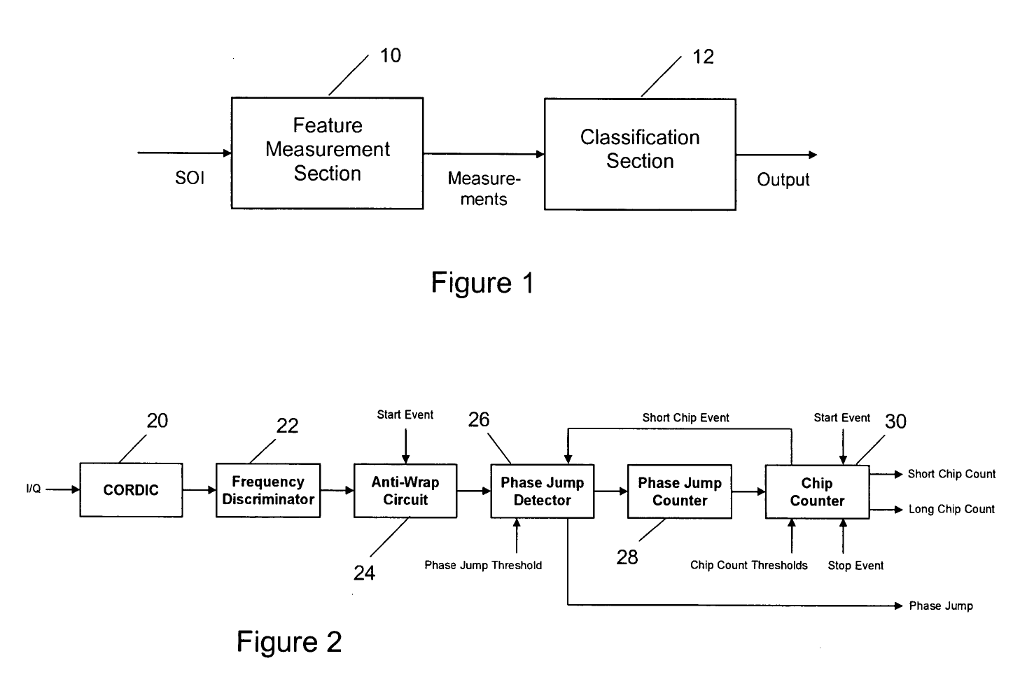

FIG. 1 shows a block diagram of a general feature measurement and classification system designed to produce an estimate of the intentional modulation present on a signal pulse. As shown in FIG. 1, the system may be divided into two sections: a feature measurement section 10 and a classification section 12. The input signal or signal of interest (SOI) is input to the feature measurement section 10 which measures various features of the SOI. The measurements made on the SOI by the feature measurement section 10 are passed to the classification section 12. The classification section 12 processes the measurements and outputs an estimate of the modulation type on the SOI and in many cases provides a confidence level for the estimate.

Feature Measurement Section 10

The classification section 12 utilizes several features measured by the feature measurement section 10, including pulse duration, long and short chip counts, phase jumps, phase state count, and a phase modulation polynomial coefficient vector. The SOI that is input to the feature measurement section 10 is preferably converted to digitized, baseband In-Phase/Quadrature (I/Q) samples and passes through a device that detects the leading edge (pulse start event) and trailing edge (pulse stop event) of the pulse, and measures the pulse duration. There are many devices known in the art for performing such functions, one being a digital channelized receiver parameter encoder. The other features of the SOI are derived from the digitized, baseband I/Q data samples of the SOI.

Chip Counts and Phase Jumps

Phase-shift keyed (PSK) and frequency-shift keyed (FSK) signals contain sub-pulse durations of constant phase or frequency known as chips. In the context of this disclosure, the term “short chip” will be used to refer to a pulse that occurs within the signal processor as a result of a constant phase chip, and the term “long chip” will be used to refer to a pulse that occurs at the same point within the signal processor as a result of a constant frequency chip. Neither “short chip” nor “long chip” necessarily refers to the duration of the actual frequency or phase chips. Both types of chips may be found by monitoring the phase of the signal when the pulse is present, and counting consecutive samples of changing phase. FIG. 2 shows a block diagram of one possible system for measuring chip counts and phase jumps in the feature measurement section 10.

In the system shown in FIG. 2, the start event and stop event inputs refer to the detection of the leading and trailing edges, respectively, of the pulse from the SOI. These inputs can be produced along with the pulse duration measurement. The phase jump and chip count thresholds are fixed values which are programmed into their respective blocks as shown.

I/Q data samples are input to a CORDIC (COordinate Rotation DIgital Computer) 20, which is simply a hardware-efficient method of converting I/Q data into amplitude and phase. The phase output of the CORDIC connects to a frequency discriminator 22 which performs a difference operation on the input data with a programmable delay. The programmable delay is preferably set to four samples. This delay is useful because it reduces the noise and accounts for chip transitions that are not instantaneous. The output of the frequency discriminator 22 is similar to a frequency measurement, although it is not exactly frequency because the delay is not exactly equal to one. The actual discriminator output is given by φᵢₙ(n)−φᵢₙ(n−4)=4Tₛfᵢₙ(n), where Tₛ is the sample period and fᵢₙ is the frequency of the input signal.

The output of the frequency discriminator 22 is fed to an anti-wrap circuit 24 which also has a start event input. The output of the frequency discriminator 22 will appear to have a DC bias that depends on the frequency of the input data. It may also have large spikes where phase wraps occur from +π to −π (or vice versa for a negative frequency). The anti-wrap circuit 24 first removes the carrier frequency by latching the discriminator output near the beginning of the pulse using the start event input and subtracting the latched value from the remainder of the data. A modulo operation is performed on the result to wrap the spikes back near zero. The current process is to compute two times the result, add one, perform a modulo two operation, and then subtract one. However, as those skilled in the art will recognize, this process is specific to the number system and scale factor used by the hardware; whether finite precision or floating point hardware is used, and whether modulo 2 or modulo 1 is used will depend on the binary point location.

The output of the anti-wrap circuit 24 is connected to the phase jump detector 26. An abrupt change in phase at the output of the CORDIC 20 will appear as a pulse at the output of the frequency discriminator 22. The duration of the pulse will be equal to the discriminator delay (nominally four samples). A change in frequency will result in a pulse, but the duration will be the same as the constant frequency chip duration of the input signal. The phase jump detector 26 monitors the phase from one sample to the next, and outputs a “1” if the jump level exceeds a pre-programmed phase jump threshold. Another feature that will be detailed later requires that the latest jump level be latched in the event that it is desired for additional processing. This is the reason for the short chip event input and phase jump output shown on the phase jump detector 26.

The output of the phase jump detector 26 is connected to the phase jump counter 28. The phase jump counter 28 counts the number of consecutive samples above the threshold. A sampling interval during which a sample is below the threshold will cause the phase jump counter 28 to reset.

The output of the phase jump counter 28 is connected to the chip counter 30. The chip counter 30 utilizes two separate, preprogrammed thresholds: one for short chip count, and one for long chip count, as well as start event and stop event inputs, indicating the leading and trailing edges of the pulse, respectively. As mentioned above, a phase change from a PSK signal will produce a pulse with duration equal to the delay of the frequency discriminator. The short chip count threshold is set equal to this discriminator delay, so each phase transition will cause the short chip count to increment. A frequency change from an FSK signal will cause small phase jumps that still exceed the threshold in the phase jump detector, but are not limited to the discriminator delay. Experiments have determined that eight of these jumps are sufficient to interpret the signal as having FSK modulation, so the long chip count threshold is preferably set to eight.

Phase jumps are used as a feature and also to derive the number of phase states. When a short chip is detected by the chip counter 30, a short chip event signal is sent to the phase jump detector 26 which outputs the magnitude of the phase jump.

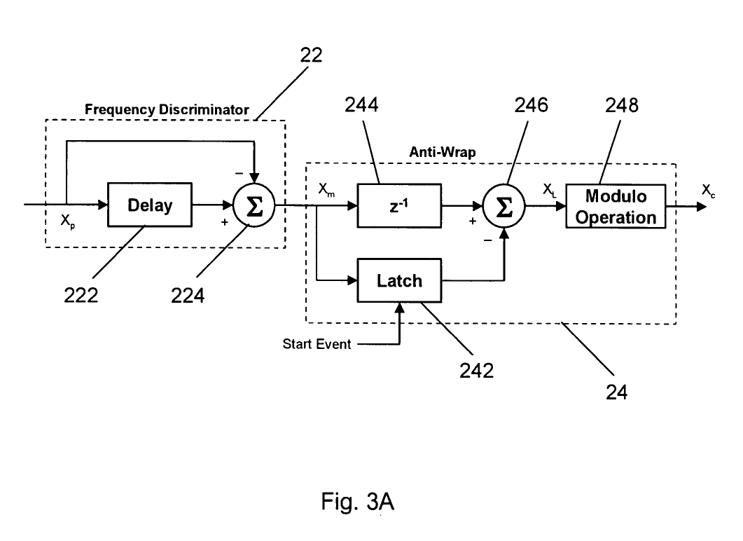

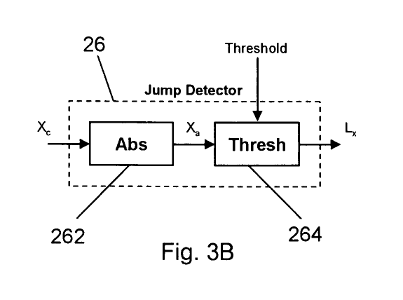

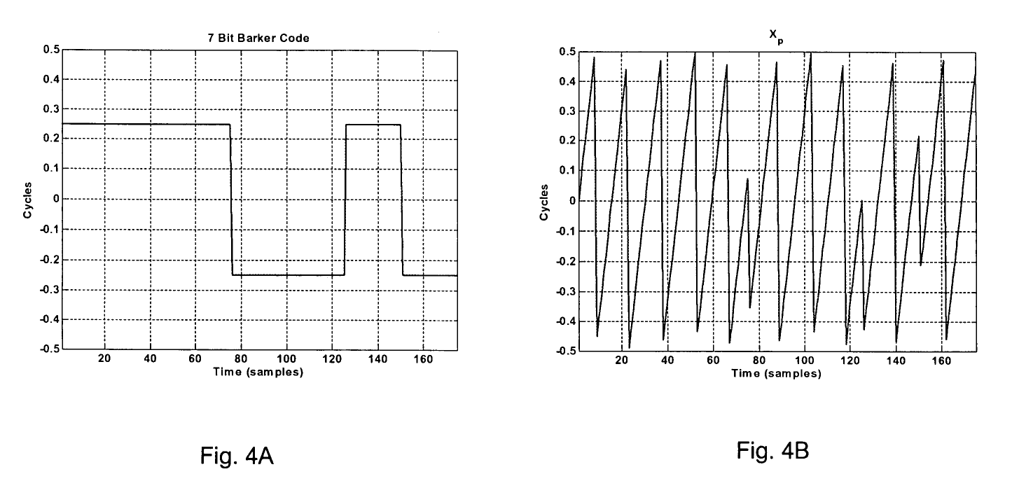

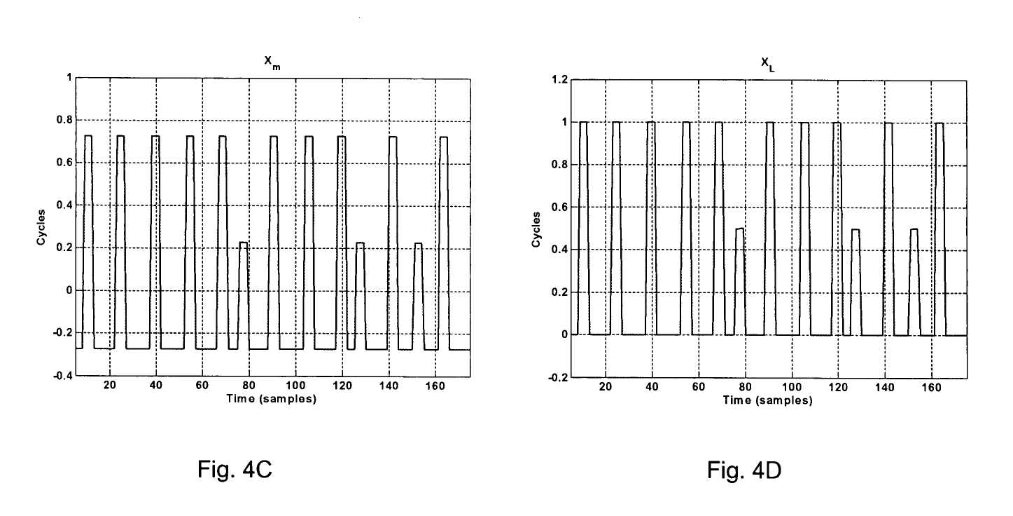

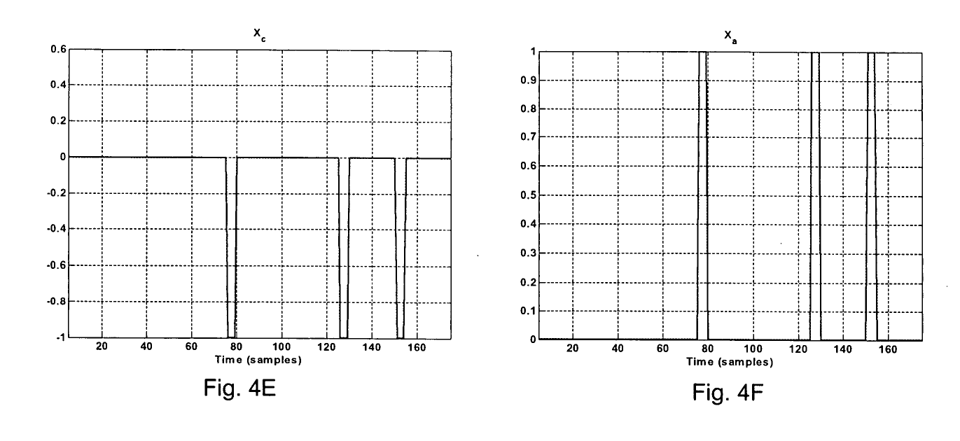

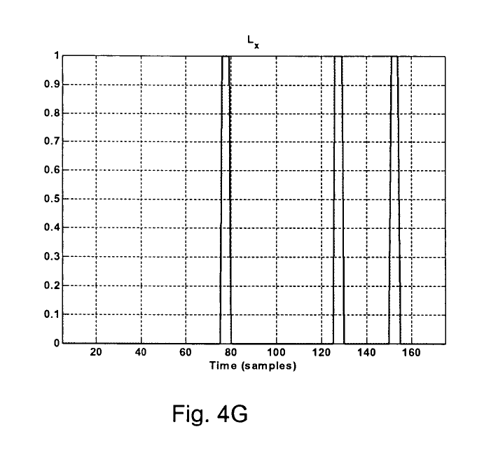

FIGS. 3A and B provide a more detailed diagram of this portion of the feature measurement section 10, along with FIGS. 4A-G which trace a signal with PSK modulation through this more detailed diagram.

FIG. 4A shows a baseband PSK Barker code phase modulation on the input signal with PSK modulation, and more specifically with a 7-bit Barker code. FIG. 4B shows this signal with Barker code modulation and with a residual carrier frequency component at the phase output of the CORDIC 20 which is the input signal Xₚ at the input of the frequency discriminator 22 shown in FIG. 3A.

The frequency discriminator 22 in FIG. 3A shows the programmable delay 222 and the difference operation 224. When the input signal Xₚ passes through the programmable delay 222 and the difference operation 224, it emerges as signal Xₘ shown in FIG. 4C. An abrupt change in phase at the output of the CORDIC 20 appears as a pulse at the output of the frequency discriminator 22, and the duration of the pulse is equal to the delay introduced by the programmable delay 222. As shown in FIG. 4C, the signal Xₘ appears to have a negative DC bias due to the frequency component and large spikes where phase wraps occur from +π to −π.

The output Xₘ of the frequency discriminator 22 is input to the anti-wrap circuit 24. The anti-wrap circuit 24 in FIG. 3A is shown to include a latch 242, a delay 244, a difference operation 246 and a modulo operation 248. The anti-wrap circuit 24 first removes the bias caused by the carrier frequency using the latch 242 which latches the value of the signal Xₘ when it receives a start event signal indicating the leading edge of the pulse. The difference operation 246 subtracts the value in the latch 242 from the remainder of the data in the signal Xₘ producing signal X_{L} shown in FIG. 4D. Note the bias is removed from signal X_{L}. The signal X_{L} is then input to the modulo operation 248 producing the signal X_{c} shown in FIG. 4E. The modulo operation is equivalent to X_{c}=mod(2X_{L}+1,2)−1. Note that the large spikes due to phase wraps from +π to −π are removed from the signal X_{c}.

The output X_{c} of the anti-wrap circuit 24 is input to the phase jump detector 26. The phase jump detector 26 in FIG. 3B is shown to include an absolute value circuit 262 and a threshold detector 264. The phase jump detector 26 first takes the absolute values of the signal X_{c} using the absolute value circuit 262 which results in signal Xₐ shown in FIG. 4F. The signal Xₐ is then input to the threshold detector 264 which monitors the phase from one sample to the next and outputs a “1” if the jump level exceeds a pre-programmed phase jump threshold which produces signal Lₓ shown in FIG. 4G. The signal Lₓ is then input to the phase jump counter 28. The phase jump detector 26 also works with the chip counter 30 to output the phase jump magnitude when the chip counter 30 detects a short chip.

The output Lₓ of the phase jump detector 26 is input to the phase jump counter 28. The phase jump counter 28 will reset between each of the detected phase jumps in the signal Lₓ since they are non-consecutive threshold crossings.

The output of the phase jump counter 28 including the signal Lₓ, is input to the chip counter 30. The chip counter 30 has preprogrammed short chip count and long chip count thresholds, as well as staff and stop event inputs. A phase change from a PSK signal as used in this example produces a pulse with duration equal to the delay of the frequency discriminator 22. So each of the phase transitions in the signal Lₓ will trigger the short chip count threshold and cause the short chip count to increment. Since none of the phase transitions in the signal Lₓ are long enough to trigger the long chip count threshold, the long chip count will not increment. This is as expected for this example of an input signal with PSK modulation and no FSK modulation.

Phase State Count

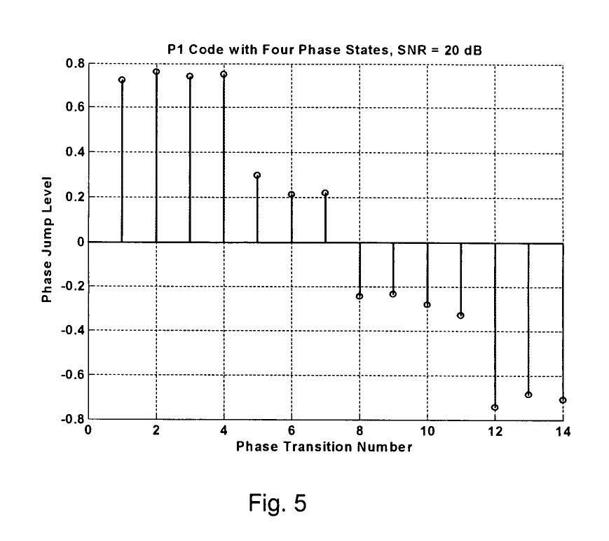

A clustering method is used to determine the number of phase states from the phase jump measurements. As described above, when the chip counter 30 detects a short chip, it sends a signal to the phase jump detector 26 which outputs the magnitude of the phase jump that triggered the short chip detection. FIG. 5 is an example, showing the phase jump levels output for a PSK P1 code modulation with four phase states and a signal-to-noise ratio of 20 dB. The phase jump levels are one-dimensional data. The number of different phase jump magnitudes is used to estimate the number of phase states. This estimate can be affected if the signal does not have all the phase jump magnitudes, or small phase jumps do not exceed the threshold, or the phase states can not be resolved at the signal-to-noise ratio of the signal.

The clustering method utilizes a distance threshold T related to cluster variance. The same threshold T is used for each cluster. The first point x₁ is used as the center of a first cluster. Then the distance D₂₁ from the second point x₂ to the center of the first cluster is computed. If this distance is greater than the threshold T a new cluster is formed with its center at x₂ . Otherwise, x₂ is assigned to the first cluster and a new center for the first cluster is computed as the center of points x₁ and x₂ . Assuming that a second cluster is created, the next step is to compute the distance from the third point to the two cluster centers (D₃₁ and D₃₂). If both are greater than T then a new cluster is started at x₃ . Otherwise, x₃ is assigned to the nearest cluster center and the new center position is computed for that cluster. The process continues until every point has been assigned to a cluster.

This method depends heavily upon the selection of the threshold T. The threshold T may be based on the signal-to-noise ratio (SNR) of the pulse:

$${σ}^{2} = \frac{1}{{π}^{2} \cdot {SNR}_{linear}}$$

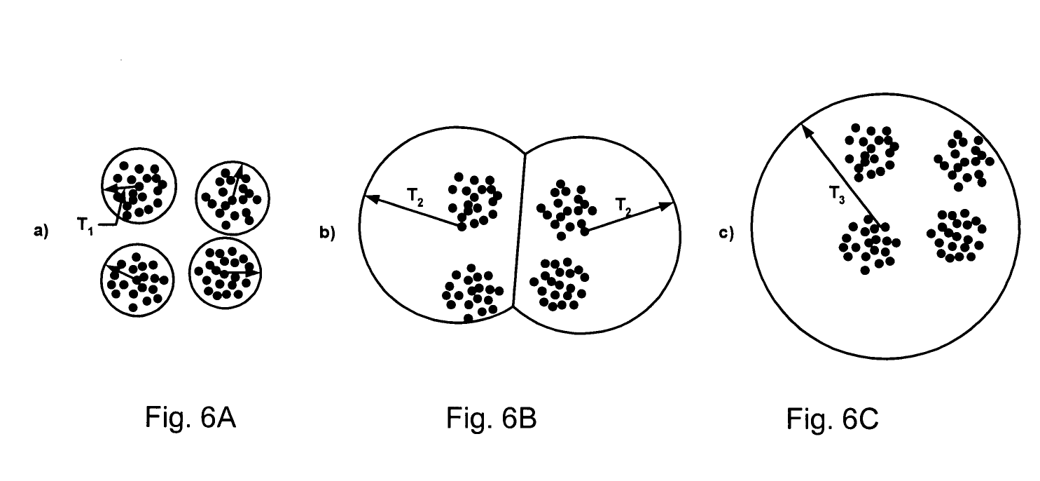

or just set to the minimum SNR expected. Although the data is one dimensional it is sometimes easier to conceptualize how clustering works using two dimensional data. The results of the method for various values of T are shown in FIGS. 6A-C. These figures show how the same data may be grouped into a different number of clusters depending on the threshold T. The clusters correspond to the phase levels.

Polynomial Coefficients

The feature measurement section 10 also includes a polynomial coefficient measurement method. These coefficients are found by fitting a polynomial to the phase waveform of the input SOI using the method of least squares (LS). The signal s(n) is assumed to be in the form

$$\begin{matrix}s ( n ) = a ( n ) {ⅇ}^{j ( 2 π {f}_{0} {T}_{s} n + ϕ ( n ) + {ϕ}_{0} )} + {w}_{s} ( n ) \\ = a ( n ) {ⅇ}^{jβ ( n )} + {w}_{s} ( n )\end{matrix} \qquad ( 1 )$$

where a(n) represents the pulse amplitude, β(n) represents the phase, and wₛ(n) represents additive noise. It is further assumed that the argument, s(n), has been extracted (e.g. using a CORDIC).
b(n)=2πf₀Tₛn+φ(n)+φ₀+w_{φ}(n) (2)

A K^{th} order polynomial fit to the data sequence b(n) is sought that has the form

$$\begin{matrix}b ( n ) = {c}_{0} + {c}_{1} \frac{2 ( n - {n}_{0} )}{N} + {c}_{2} \frac{{2}^{2} {( n - {n}_{0} )}^{2}}{{N}^{2}} + … + \\ {c}_{K} \frac{{2}^{K} {( n - {n}_{0} )}^{K}}{{N}^{K}}\end{matrix} \qquad ( 3 )$$

where n₀ is the mid point of the pulse waveform (i.e., n₀=N_{pd}/2). The terms of the form

$$\frac{{2}^{K} {( n - {n}_{0} )}^{K}}{{N}^{K}}$$

that normalize each coefficient allow the input signals to be scaled so that the final coefficients are independent of the particular pulse and chip duration. If N samples of b(n) are available, the problem can be expressed in matrix form as

$$[ \begin{matrix}b ( 1 ) \\ b ( 2 ) \\ ⋮ \\ b ( N )\end{matrix} ] = [ \begin{matrix}{( \frac{2 ( 1 - {n}_{0} )}{N} )}^{0} & {( \frac{2 ( 1 - {n}_{0} )}{N} )}^{1} & ⋯ & {( \frac{2 ( 1 - {n}_{0} )}{N} )}^{K} \\ {( \frac{2 ( 2 - {n}_{0} )}{N} )}^{0} & {( \frac{2 ( 2 - {n}_{0} )}{N} )}^{1} & ⋯ & {( \frac{2 ( 2 - {n}_{0} )}{N} )}^{K} \\ ⋮ & ⋮ & & ⋮ \\ {( \frac{2 ( N - {n}_{0} )}{N} )}^{0} & {( \frac{2 ( N - {n}_{0} )}{N} )}^{1} & ⋯ & {( \frac{2 ( N - {n}_{0} )}{N} )}^{K}\end{matrix} ] [ \begin{matrix}{c}_{0} \\ {c}_{1} \\ ⋮ \\ {c}_{K}\end{matrix} ] \qquad ( 4 )$$

Using matrix symbology
b≈Nc (5)

The LS solution for the coefficient set c that minimizes the quadratic cost function

$$\begin{matrix}{min}_{c} ‖ b - Nc ‖ {=}^{△} {C}_{ϕ} & ( 6 ) \\ is given by & \\ c = {[ {N}^{T} N ]}^{- 1} {N}^{T} b & ( 7 )\end{matrix}$$

The matrix N is referred to as the Vandermonde matrix. The phase is unwrapped for the measured values of h(n) and c is determined using Eq. (7). It has been found that a ninth-order polynomial provides a good balance between computational complexity and goodness of fit, though other order polynomials can be used.

Classification Section 12

The classification section 12 accepts the measurements from the feature measurement section 10, including phase jump levels, phase state counts, phase modulation polynomial coefficients, pulse duration, short chip count and long chip count. The classification section 12 processes the measurements of the input pulse from the feature measurement section 10 and outputs a modulation type for the input pulse and in many cases also outputs a confidence level for the selected modulation type.

The classification section 12 works on the premise that an input pulse has been reduced to a set of measured features, and that the pulse can be represented as a point in “feature space.” Feature space is a multi-dimensional coordinate system in which each dimension corresponds to and individual feature and the pulse is represented as a point in this space.

Distance Functions

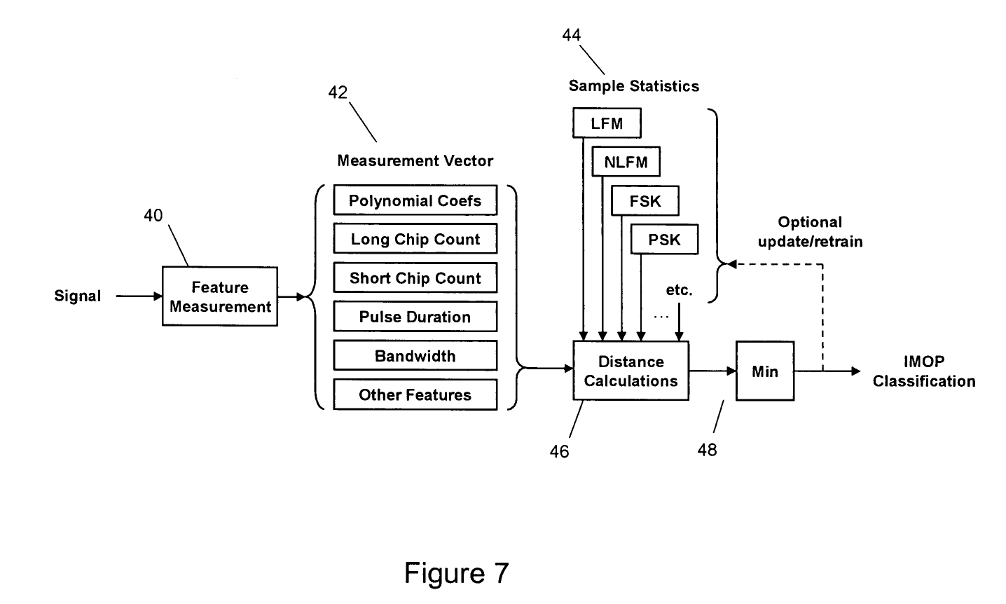

The distance function method uses the idea of feature space. The first step is to group the points for each known modulation type together in feature space. Then the mean value of each group, and other useful statistics, is computed. The mean value refers to the center of the group. As new signals with unknown modulations arrive, their location in feature space is compared to the mean values of the known groups. The feature space can consist of any combination of the available measurements. The new signal is assigned the modulation type of the closest group. FIG. 7 depicts this process.

FIG. 7 shows a feature measurement block 40 and an array of sample statistics 44. The feature measurement block 40 accepts an input signal and outputs a measurement vector 42. The sample statistics 44 contain measurement values for various known signal modulation types, such as linear frequency modulation (LFM), nonlinear frequency modulation (NLFM), FSK and PSK modulation signals. The distance calculation block 46 computes the distance from the measurement vector 42 to each of the sample statistics in the all ay of sample statistics 44. The MNN block 48 determines which of the distance calculations is the minimum and classifies the input signal as having modulation type whose sample statistic is the minimum distance from the measurement vector 42.

A distance measurement that has been found to be good for this application is the Mahalanobis distance which statistically compares the unknown signal to the set of candidate signals. The Mahalanobis distance is given by
dₛ=\sqrt{(xᵣ−xₛ)Rₛ⁻¹(xᵣ−xₛ)}^{T} (8)
where xᵣ is the unknown signal, xₛ is center for the candidate signal, and Rₛ is the sample covariance matrix of xₛ.

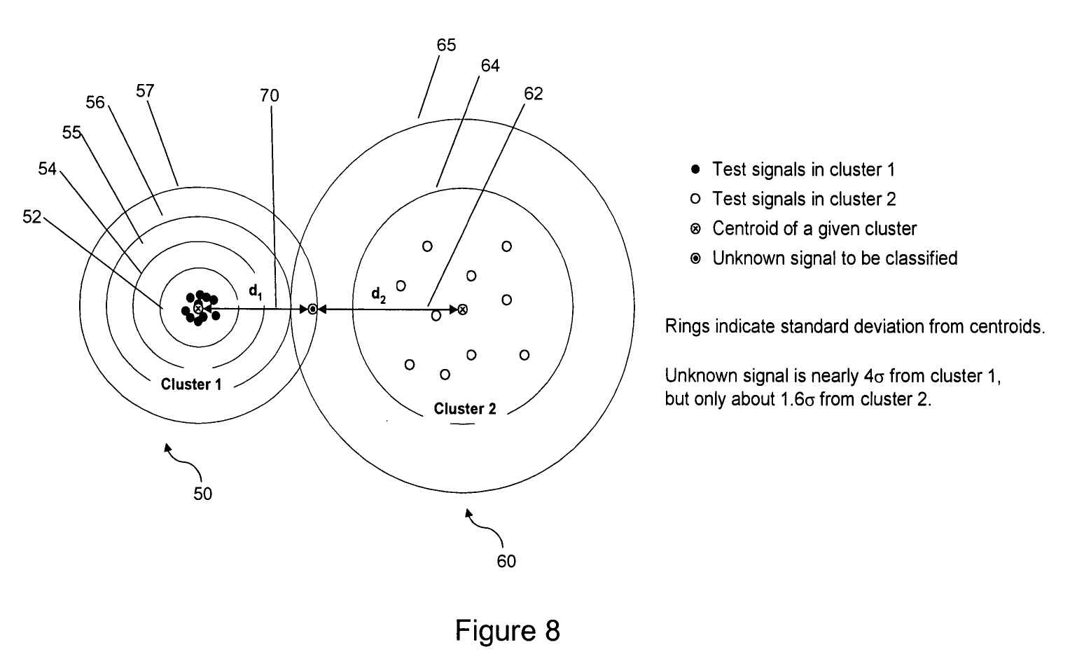

An example of the difference between Euclidean and Mahalanobis distance is shown in FIG. 8. In the following discussion, the groups of features belonging to one modulation type will sometimes be referred to as clusters. Note that this is separate from the clustering of the phase jump magnitudes mentioned earlier. FIG. 8 shows a first cluster 50 having a first centroid 52 and rings 54, 55, 56, 57 representing the first, second, third and fourth standard deviations, respectively, of the first cluster 50. The figure shows a second cluster 60 having a second centroid 62 and rings 64, 65 representing the first and second standard deviations, respectively, of the second cluster 60. The unknown signal, represented by a measurement point 70, is slightly closer to the first cluster 50 in terms of Euclidean distance. But the Mahalanobis distance takes the spread of each cluster into account. Since first cluster 50 is much tighter than second cluster 60, the measurement point 70 is almost four standard deviations from the centroid 52 of the first cluster 50 but is less than two standard deviations from the centroid 62 of the second cluster 60. Thus, the measurement point 70 has a smaller Mahalanobis distance to second cluster 60 and would be classified as having the same modulation type as cluster 60.

The sample covariance matrix for a given modulation type k is given by

$${\hat{R}}_{k} = \frac{1}{N - 1} {( {X}_{k} - {\hat{μ}}_{xk} )}^{T} ( {X}_{k} - {\hat{μ}}_{xk} ) \qquad ( 9 )$$

where Xₖ is the feature matrix of sample (training) data with each row corresponding to the pulse number and the columns corresponding to one or more features. The variable k represents the set of pulses of one modulation type. The sample mean of each of the features of group k is given by \hat{μ}ₛₖ.

Here, N refers to the number of training signals of a particular modulation type. This equation implies a two step process. First, known modulation types are input to the feature measurement system 10. The points in the feature space are grouped according to modulation type and the sample mean values and sample covariance matrices are computed and stored for each modulation type. Second, the features of the new pulse are measured and the Mahalanobis distance is computed to each known modulation type. In eq. (10) x is the new signal feature vector, \hat{μ}ₖ is the sample mean of the modulation group k, and \hat{R}ₖ is the sample covariance matrix of modulation group k.
dₖ={square root over ((x−\hat{μ}ₖ)\hat{R}ₖ⁻¹(x−\hat{μ}ₖ)^{T} (10)
This calculation is done for each modulation type k and the one with the shortest distance is the output type.

It should be noted that the mean values and sample covariance matrices (and their inverses) can be calculated beforehand and stored in memory for fast recall. This greatly reduces the computational load of performing the above calculation and can make the calculation more accurate if it is to be implemented in a fixed-precision system.

Confidence Level

The use of a minimum distance classifier makes it possible to create a confidence measure. This is done by comparing the shortest distance to the remaining distances. An ideal case would have the input right at the mean of one cluster and infinitely far away from the other clusters. This is not possible but it provides an upper bound on performance. The worst case scenario is that the incoming point is equidistant from all of the clusters.

The following measure was derived as a confidence level that also normalizes the ideal and worst cases described above to output one (highest confidence) and zero (lowest confidence), respectively.

$$C = \frac{1 / {d}_{i}}{{\sum }_{j = 1}^{N} 1 / {d}_{j}} \qquad ( 11 )$$

where i is the index of the nearest cluster, d is the Mahalanobis distance, and N is the number of clusters. This equation works by giving less weight to clusters when they are far away and more weight to clusters nearby. This is a natural result of distances always being positive.

Classification Method

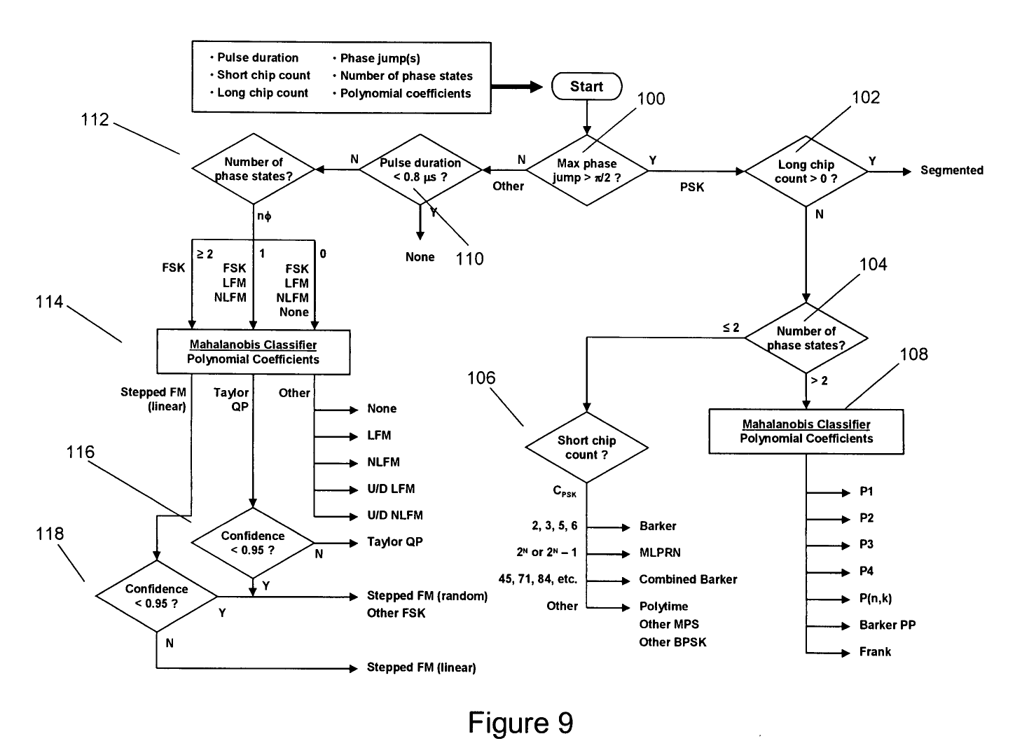

The classification section 12 uses a combination of rule-based and distance-based, or similarity-based, classification methods. A flow diagram of the method implemented in the classification section 12 is shown below in FIG. 9.

At step 100, the maximum phase jump is checked. This is intended to separate phase shift keying (PSK) signals from all other types. Phase jumps are the size of the phase discontinuities of a given pulse. If the maximum phase jump magnitude for the input pulse is greater than π/2 then the signal is deemed to have PSK modulation and control is passed to step 102. This assumes that any noise on continuous pulses should not create a phase discontinuity that large, and that most PSK signals will have at least one transition that is large in order to take advantage of all the available phase states.

Step 102 checks the long chip count. Recall that step 100 only passed signals to this step with PSK modulation, and that the long chip count is incremented whenever there is a frequency shift keying (FSK) transition but not when there is a PSK transition. Therefore, this test looks for FSK modulations within PSK signals, which by definition is segmented modulation. If the long chip count is greater than 0, then the output of the classification section 12 is set to indicate that the input signal has segmented modulation. If the long chip count is not greater than 0, then control is passed to step 104.

Step 104 checks the measurement of the number of phase states to separate binary phase shift keying (BPSK) from multiple phase shift keying (MPSK) modulations. If the number of phase states is less than or equal to 2 then the pulse has BPSK modulation and control is passed to step 106, otherwise the pulse is considered to have MPSK modulation and control is passed to step 108.

Step 106 discriminates between the various types of BPSK signals using the short chip count. If the short chip count is 2, 3, 5 or 6, then the output of the classification section 12 is set to indicate that the input signal has Barker coded BPSK signal modulation. If the short chip count is 2″ or 2″−1, where n≧6, then the output of the classification section 12 is set to indicate that the input signal has Maximum Length Pseudorandom Noise (MLPRN) modulation. If the short chip count is 4, 7, 9, 10, 12, 13, 14, 16, 17, 19, 21, 22, 24, 25, 26, 27, 32, 38, 45, 60, 71, or 84, then the output of the classification section 12 is set to indicate that the input signal has Combined Barker coded BPSK modulation. If the short chip count does not fit any of these classifications, then the output of the classification section 12 is set to indicate that the input signal has “Other BPSK” modulation, which includes Polytime and Minimum Peak Sidelobes (MPS) modulations not otherwise classified.

At step 108, the Mahalanobis classifier is used to find the MPSK modulation type most similar to the input signal. The mean value vectors and sample covariance matrices for the polynomial coefficients of each of the MPSK modulation types (P1, P2, P3, P4, P(n,k), Barker PP and Frank) are preferably stored in memory. Then using Eq. (11), the Mahalanobis distance from the input signal vector to each modulation type is computed and the output of the classification section 12 is set to indicate the modulation type with the closest distance and the calculation of Eq. (12) is used to provide a confidence level for this classification.

Returning to step 100, if the maximum phase jump for the input pulse is not greater than π/2 then the signal is deemed not to be a PSK signal and control is passed to step 110. Step 110 checks whether the pulse duration is less than 0.8 microseconds (μsec). This test is performed to find unmodulated pulses. Pulses with very small pulse durations are very unlikely to have any intentional modulation on pulse, IMOP. This threshold is set so that it may not detect a large percentage of the unmodulated pulses, but this is not a problem because there is another test later to find the rest of the unmodulated pulses. If the pulse duration is less than 0.8 μsec, then the output of the classification section 12 is set to indicate that the input signal has no IMOP, otherwise control is passed to step 112.

Step 112 checks the number of phase states, but the outputs of this decision are not mutually exclusive. The intent is simply to narrow the candidate modulation types according to the number of phase states. If there are no phase states, then the candidate modulation types include any of the possible inputs (FSK, Chirp, unmodulated, etc,). If there is one phase state, then the candidate modulation types can be any of the possible inputs except unmodulated (sometimes chirps register as having one phase state). If there are two phase states, then the only candidate modulation type is FSK modulation.

Following step 112, control is passed to another Mahalanobis classifier in step 114. As was done with the Mahalanobis Classifier (108), this Mahalanobis classifier also uses the polynomial phase coefficients. The set of possible outputs from the Mahalanobis classifier comes from the results of step 112. It is only the narrowed set of candidate modulation types determined in step 112 to which the Mahalanobis distance is calculated in step 114.

There are seven possible outputs from the Mahalanobis classifier at step 114, but there may be fewer depending on the number of phase states found in step 112. For zero phase states, the possible Mahalanobis classifier outputs include unmodulated, Linear Frequency Modulated (LFM), Nonlinear Frequency Modulated (NLFM), Up/Down (U/D) LFM, U/D NLFM, linear Stepped Frequency Modulated (SFM), and Taylor Quadriphase. For exactly one phase state, the possible Mahalanobis classifier outputs include all those listed for the zero phase state case, except for unmodulated. For two or more phase states, the possible Mahalanobis classifier outputs include only linear SFM, and Taylor QP. The Mahalanobis distance from the input signal vector to each modulation type in the set of candidate modulation types determined in step 112 is computed and the modulation type with the closest distance is assigned to the input signal. A confidence level for the assigned modulation type is also computed.

When the output modulation type from step 114 is Taylor QP, then step 116 checks if the confidence level for the classification is below 0.95. If the confidence level is below 0.95, then the classification of the pulse modulation is changed to random SFM/other FSK, otherwise the classification remains Taylor QP.

When the output modulation type from step 114 is linear SFM, then step 118 checks if the confidence level for the classification is below 0.95. If the confidence level is below 0.95, then the classification of the pulse modulation is changed to random SFM/other FSK, otherwise the classification remains linear SFM.

Classification Algorithm Performance

The performance of the classifier has been quantified by an confusion matrix. This matrix has the input types as the rows and the output types as the columns. Each cell contains the number of signals classified as the modulation indicated by its column when the true modulation is indicated by its row. If the number of input types and output types are equal, the ideal matrix would be diagonal.

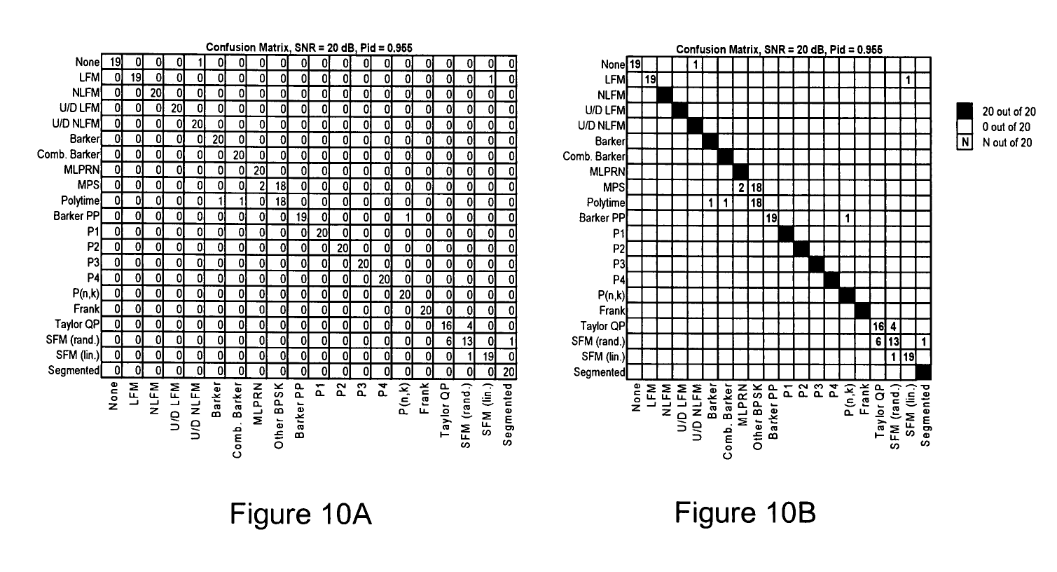

The feature measurement and classification system 8 has 21 input types and 20 output types. For performance evaluation, 20 signals of each input type were used. The result is a confusion matrix shown in FIG. 10A which is also shown graphically in FIG. 10B. The intensity bar on the right of the graph indicates the meaning of each shade. As a general rule of thumb, the results should fall on the diagonal. Since there is one fewer output than input (Polytime and MPS code modulations are combined into a single BPSK modulation type), the ideal case is not quite a diagonal matrix.

Notice that the heading to these confusion matrices contains a value called P_{id}. This number is the overall probability of correct identification. It is formulated by dividing the total number of signals that were classified correctly by the total number of signals input to the classifier. This is a simple way of expressing the effectiveness of the classifier as a single number, instead of having to display many ambiguity matrices. The results shown below use this number.

Three training methods were attempted in training this classifier. One method stored the sample covariance matrices and mean values for the training library at each signal-to-noise ratio (SNR) tested. Another method stored these values at a low SNR only (15 dB). The third method stored the values at a high SNR only (40 dB). The SNRs at which the classifier was tested were: 5, 10, 15, 20, 25, 30, 40, and 60 dB.

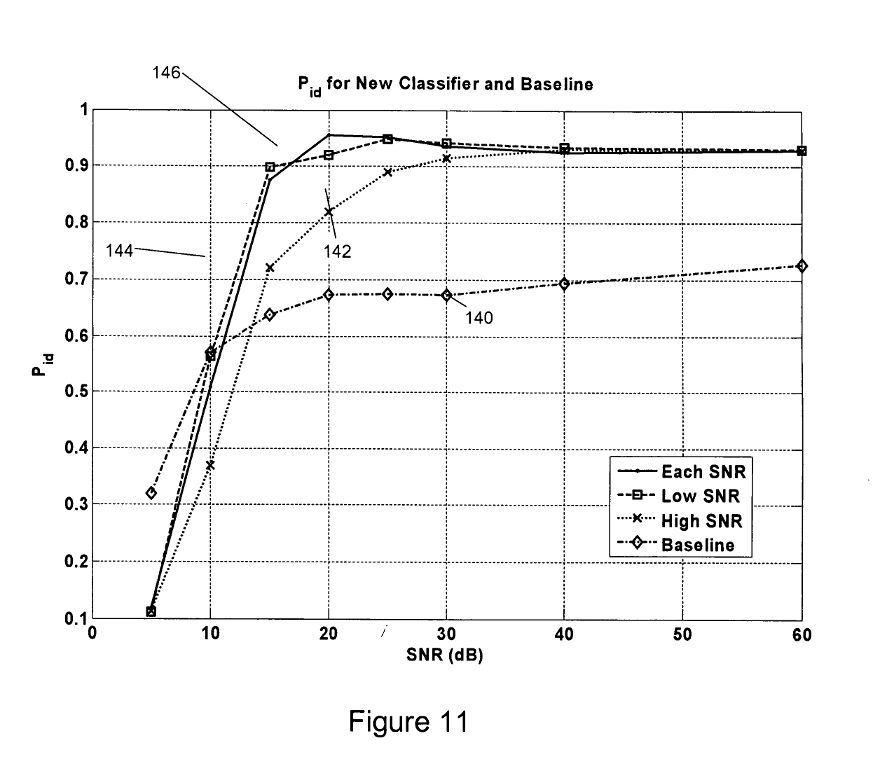

FIG. 11 shows the performance of the feature measurement and classification system 8 for each of the training approaches outlined above, as well as the performance of an earlier “baseline” system optimized for the same signal set of data used to train the invention. The plot of the performance of the present invention when trained with high SNR signals is shown by high SNR line 142. The plot of the performance of the present invention when trained with low SNR signals is shown by low SNR line 144. The plot of the performance of the present invention when trained with each SNR signals is shown by each SNR line 146. The plot of the performance of the baseline system is shown by the baseline line 140.

The graph in FIG. 11, indicates that for high SNR unknown signals (above 30 dB) the performance of the present system 8 is very similar, at about 0.92, regardless of the training method. However, when the system 8 is trained with high SNR signals, the performance is not as good for low SNR unknown input signals (10-30 dB). The graph also shows that the performance of the baseline classifier asymptotically approaches a P_{id} of about 0.73 as opposed to the classifier of the present invention which is about 0.93. The performance of the present invention is significantly better for unknown input signals with SNR above about 12 dB. Also note that the baseline system only has 6 output types, whereas the classifier of the present invention has 20 output types.

Although the present invention has been described with reference to certain exemplary embodiments, it is understood that variations and modifications exist and are within the scope of the present invention.

We claim:

1. A modulation feature measurement and classification system for classifying a pulsed signal, the modulation feature measurement and classification system comprising:
a preprocessor that detects a pulse start and a pulse stop, and that measures pulse duration for the pulsed signal and that converts the pulsed signal into a plurality of digitized baseband in-phase/quadrature samples;
a phase measurement system that measures short chip counts, long chip counts, phase jump magnitudes, number of phase states, and phase modulation polynomial coefficients for a curve fit to a phase waveform for the pulsed signal; and
a modulation classifier that determines a modulation type of the pulsed signal based on the measurements of the preprocessor and the phase measurement system using both rules-based and similarity-based classification methods.

2. The modulation feature measurement and classification system of claim 1, wherein the modulation classifier uses both rule-based and similarity-based classification methods to classify the modulation type of the pulsed signal.

3. The modulation feature measurement and classification system of claim 1, wherein the modulation classifier classifies the pulsed signal as having phase shift keyed modulation if the phase jump magnitude exceeds π/2.

4. The modulation feature measurement and classification system of claim 1, wherein the modulation classifier uses Mahalanobis distance for the similarity-based classification methods.

5. The modulation feature measurement and classification system of claim 1, wherein the phase measurement system comprises:
a coordinate rotation digital computer for converting the plurality of digitized baseband in-phase/quadrature samples into a plurality of amplitude and phase samples;
a phase jump detector for measuring a phase jump magnitude between consecutive phase samples and detecting when the phase jump magnitude exceeds a phase jump threshold;
a phase jump counter for counting the number of consecutive times the phase jump magnitude exceeds the phase jump threshold, the phase jump counter resetting when the phase jump magnitude fails to exceed the phase jump threshold;
a chip counter for measuring the short chip counts and the long chip counts;
a phase state counter for determining the number of phase states from the phase jump magnitude measurements made by the phase jump detector; and
a processor for determining the phase modulation polynomial coefficients.

6. The modulation feature measurement and classification system of claim 5, wherein the phase state counter determines the number of phase states using a clustering method with a threshold distance measure.

7. The modulation feature measurement and classification system of claim 5, wherein the phase measurement system further comprises:
a frequency discriminator that performs a difference operation with a programmable delay on the plurality of phase samples from the coordinate rotation digital computer; and
an anti-wrap circuit that removes a carrier frequency bias and large spikes due to phase wraps from the output of the frequency discriminator.

8. The modulation feature measurement and classification system of claim 7, wherein the preprocessor generates a start event signal when detecting a pulse leading edge and generates a stop event signal when detecting a pulse trailing edge, the start event signal being sent to the anti-wrap circuit and the chip counter, and the stop event signal being sent to the chip counter.

9. The modulation feature measurement and classification system of claim 8, wherein the chip counter uses a short chip count threshold and a long chip count threshold, the short chip count threshold being equal to the programmable delay of the frequency discriminator.

10. The modulation feature measurement and classification system of claim 5, wherein the processor for determining the phase modulation polynomial coefficients uses a least squares method to fit a K-th order polynomial of the form:
$$b ( n ) = {c}_{0} + {c}_{1} \frac{2 ( n - {n}_{0} )}{N} + {c}_{2} \frac{{2}^{2} {( n - {n}_{0} )}^{2}}{{N}^{2}} + … + {c}_{K} \frac{{2}^{K} {( n - {n}_{0} )}^{K}}{{N}^{K}}$$
to the phase waveform of the input signal, where n₀ is the midpoint of the waveform, N is the total number of samples, and the cᵢ are the desired polynomial coefficients.

11. A rule and distance based method for classifying the modulation of a pulsed signal, comprising:
accepting measurements of pulse duration, short chip count, long chip count, phase jump magnitude, number of phase states and phase modulation polynomial coefficients for the pulsed signal;
classifying the pulsed signal as having phase-shift keyed modulation if the maximum phase jump magnitude is greater than π/2;
if the pulsed signal is classified as having phase-shift keyed modulation, determining whether the long chip count is greater than zero;
if the pulsed signal is classified as having phase-shift keyed modulation and the long chip count is greater than zero, classifying the pulsed signal as having segmented modulation;
if the pulsed signal is classified as having phase-shift keyed modulation and the long chip count is zero, determining whether the number of phases states is greater than two;
if the pulsed signal is classified as having phase-shift keyed modulation, the long chip count is zero, and the number of phases states is not greater than two, classifying the pulsed signal as having binary phase-shift keyed modulation;
if the pulsed signal is classified as having phase-shift keyed modulation, the long chip count is zero, and the number of phases states is greater than two, classifying the pulsed signal as having multiple phase-shift keyed modulation;
if the pulsed signal is not classified as having phase-shift keyed modulation, determining whether the pulse duration is less than about 0.8 microseconds;
if the pulsed signal is not classified as having phase-shift keyed modulation and the pulse duration is less than about 0.8 microseconds, classifying the pulsed signal as having no pulse modulation; and
if the pulsed signal is not classified as having phase-shift keyed modulation and the pulse duration is not less than about 0.8 microseconds, using the number of phase states to classify the modulation of the pulsed signal.

12. The method of claim 11, wherein the step of classifying the pulsed signal as having binary phase-shift keyed modulation comprises:
using the short chip count to determine the type of binary phase-shift keyed modulation;
classifying the pulsed signal as having Barker coded binary phase-shift keyed modulation if the short chip count is 2, 3, 5 or 6;
classifying the pulsed signal as having maximum length pseudorandom noise modulation if the short chip count is 2″ or 2″−1, where n≧6;
classifying the pulsed signal as having combined Barker coded binary phase-shift keyed modulation if the short chip count is 4, 7, 9, 10, 12, 13, 14, 16, 17, 19, 21, 22, 24, 25, 26, 27, 32, 38, 45, 60, 71, or 84; and
otherwise classifying the pulsed signal as having other binary phase-shift keyed modulation.

13. The method of claim 11, wherein the step of classifying the pulsed signal as having multiple phase-shift keyed modulation comprises:
utilizing a distance-based method to determine the type of multiple phase-shift keyed modulation based on the phase modulation polynomial coefficients of the pulsed signal and parameters for different multiple phase-shift keyed modulation types.

14. The method of claim 13, wherein the distance-based method is the Mahalanobis classifier, and the parameters for different multiple phase-shift keyed modulation types are the mean value vectors and sample covariance matrices of the polynomial fit phase coefficients for the different multiple phase-shift keyed modulation types.

15. The method of claim 14, further comprising calculating a confidence level for the classification of the type of multiple phase-shift keyed modulation.

16. The method of claim 11, wherein the step of using the number of phase states to classify the modulation of the pulsed signal, if the pulsed signal is not classified as having phase-shift keyed modulation and the pulse duration is not less than about 0.8 microseconds, comprises:
further classifying the pulsed signal as having frequency-shift keyed modulation if the number of phase states is greater than 1;
further classifying the pulsed signal as having one of frequency-shift keyed modulation, linear frequency modulation, or non-linear frequency modulation if the number of phase states is equal to 1; and
further classifying the pulsed signal as having one of frequency-shift keyed modulation, linear frequency modulation, non-linear frequency modulation, or no modulation if the number of phase states is equal to 0.

17. The method of claim 16, wherein each of the steps of further classifying the pulsed signal comprises:
utilizing a distance-based method to determine the type of modulation based on the phase modulation polynomial coefficients of the pulsed signal and parameters for the different possible modulation classifications for a pulsed signal with the number of phase states.

18. The method of claim 17, wherein the distance-based method is the Mahalanobis classifier, and the step of further classifying the pulsed signal as having frequency-shift keyed modulation further comprises:
assigning the pulsed signal as having one of linear stepped frequency modulation or Taylor quadraphase modulation utilizing the Mahalanobis classifier;
calculating a confidence level for the assignment;
if the confidence level is less than 0.95 and the pulsed signal is assigned as having linear stepped frequency modulation, reassigning the pulsed signal as having random stepped frequency modulation/other frequency-shift keyed modulation; and
if the confidence level is less than 0.95 and the pulsed signal is assigned as having Taylor quadraphase modulation, reassigning the pulsed signal as having random stepped frequency modulation/other frequency-shift keyed modulation.

19. The method of claim 17, wherein the distance-based method is the Mahalanobis classifier, and the step of further classifying the pulsed signal as having one of frequency-shift keyed modulation, linear frequency modulation, or non-linear frequency modulation further comprises:
assigning the pulsed signal as having one of linear stepped frequency modulation, Taylor quadraphase, linear frequency modulation, non-linear frequency modulation, up/down linear frequency modulation or up/down non-linear frequency modulation utilizing the Mahalanobis classifier;
calculating a confidence level for the assignment;
if the confidence level is less than 0.95 and the pulsed signal is assigned as having linear stepped frequency modulation, reassigning the pulsed signal as having random stepped frequency modulation/other frequency-shift keyed modulation; and
if the confidence level is less than 0.95 and the pulsed signal is assigned as having Taylor quadraphase modulation, reassigning the pulsed signal as having random stepped frequency modulation/other frequency-shift keyed modulation.

20. The method of claim 17, wherein the distance-based method is the Mahalanobis classifier, and the step of further classifying the pulsed signal as having one of frequency-shift keyed modulation, linear frequency modulation, non-linear frequency modulation, or no modulation, comprises:
assigning the pulsed signal as having one of linear stepped frequency modulation, Taylor quadraphase, linear frequency modulation, non-linear frequency modulation, up/down linear frequency modulation, up/down non-linear frequency modulation, or no modulation utilizing the Mahalanobis classifier;
calculating a confidence level for the assignment;
if the confidence level is less than 0.95 and the pulsed signal is assigned as having linear stepped frequency modulation, reassigning the pulsed signal as having random stepped frequency modulation/other frequency-shift keyed modulation; and
if the confidence level is less than 0.95 and the pulsed signal is assigned as having Taylor quadraphase modulation, reassigning the pulsed signal as having random stepped frequency modulation/other frequency-shift keyed modulation.
